(19) United States
(12) Patent Application Publication
(10) Pub. No.: US 2011/0156370 A1
(43) Pub. Date: Jun. 30, 2011

(54) Trailer Hitch Receiver Tube Having an Offset Receptacle Mouth

(75) Inventor: Frank Burger, Brandon Township, MI (US)

(73) Assignee: GM GLOBAL TECHNOLOGY OPERATIONS, INC., DETROIT, MI (US)

(21) Appl. No.: 12/649,629

(22) Filed: Dec. 30, 2009

(51) Int. Cl. B60D 1/54

(52) U.S. Cl. 280/491.2

(57) ABSTRACT

An offset mouth of a trailer hitch receiver tube. An offset is provided in at least the receiver tube receptacle bottom wall beginning at an offset inception location spaced from the receiver tube receptacle mouth edge, whereby the offset provides an increased receptacle mouth opening size of the trailer hitch receiver tube from the offset inception location to the receiver tube receptacle mouth edge.

### TECHNICAL FIELD

The present invention relates to trailer hitches, and more particularly to the receiver tube therefor. More particularly, the present invention relates to an offset receptacle mouth trailer hitch receiver tube.

### BACKGROUND OF THE INVENTION

In order for a trailer to be articulately connected to the rear of a motor vehicle, a trailer hitch and socket system is utilized. Generally, the trailer has an elongated tongue distally terminating, forwardly of the trailer, with a claspable socket. The trailer hitch emanates from the rear of the motor vehicle, having a ball which is received by the socket, whereupon when the socket clasps the ball the trailer is connected to the motor vehicle, allowing articulation between the motor vehicle and the trailer at the ball and socket interface. The ball commonly has a threaded shank which is used to affix the ball in upstanding relation to a horizontally oriented drawbar which is, in turn, affixed to the rear of the motor vehicle, usually at the frame.

Depicted at FIG. 1 is a common form of heavy duty trailer hitch 10 of the “receiver” type, wherein a trailer hitch receiver tube 12 has a quadrilaterally cross-sectioned receiver tube receptacle 12a. The trailer hitch receiver tube 12 is affixed to the frame of the motor vehicle 14, and a removable drawbar 16 having a corresponding quadrilaterally cross-sectioned drawbar stem 16a, is operably receivable by the receiver receptacle. In this regard, the drawbar stem 16a is removably connected to the trailer hitch receiver tube 12, as for example by one or more selectively removable pins 18 which pass through both the trailer hitch receiver tube and the drawbar stem. Connected to the drawbar 16 is the ball 20 which interfaces with a trailer socket (not shown).

As illustrated schematically at FIG. 2, a drawbar trailer load 22 bears down upon the ball 20, wherein the drawbar trailer load is transferred as an acting receiver tube load 24 disposed at the receiver tube receptacle mouth edge 26 which acts upon the tube receptacle bottom wall 28B. The torque moment established between the drawbar trailer load 22 and the acting receiver tube load 24 produces a reacting receiver tube load 30 disposed at the end of the drawbar stem 16a which acts upon the receiver tube receptacle top wall 28T and augments the acting receiver tube load at the receiver tube receptacle mouth edge. Because the acting receiver tube load 24 is disposed at the tube receptacle mouth edge 26, there is a tendency over time for impulse loads, which are included in the acting receiver tube load 24 and arise due to driving over non-uniform road surfaces, to cause the trailer hitch receiver tube 12 to distort, crack or otherwise fail.

Referring now to FIG. 3, the acting receiver tube load 24 is depicted as a lateral load distribution 24L extending across the receiver tube receptacle bottom wall 28B at the receiver tube receptacle mouth edge 26, between the receiver tube receptacle left and right walls 28L, 28R. As can be understood by the relative lengths of the arrows (a relatively longer arrow representing a relatively higher force magnitude), the acting receiver load 24 has highest magnitude adjacent the receiver tube receptacle left and right walls 28L, 28R, whereby high stress is applied to the receiver tube receptacle mouth edge 26 at the bottom wall left and bottom wall right corner areas 32L, 32R, whereat distortion, cracking or other failure will generally be noticed first.

In order to handle the stress applied to the receiver tube receptacle mouth edge 26 at the bottom wall left and bottom wall right corner areas 32L, 32R, prior art trailer hitch receiver tubes 12 have traditionally employed some form of receiver tube end portion reinforcement 34 at the receiver tube receptacle mouth edge 26, as shown at FIGS. 1, 4A and 4B. The receiver tube end portion reinforcement make take many forms to provide extra material for providing external reinforcement at the receiver tube receptacle mouth edge, for example, as a separate ring or cast collar 34′ (shown at FIG. 4A) welded to the trailer hitch receiver tube, or as a single-piece construction 34″ (shown at FIG. 4B) with hot or cold formed reinforcement (upset, forging, etc.) at the receiver tube receptacle mouth edge.

What remains needed in the art is a trailer hitch receiver tube which is able to accept bottom wall corner stress without need to add receiver tube end portion reinforcement, and its detrimental added weight, manufacturing, and material cost, at the receiver tube receptacle mouth edge.

### SUMMARY OF THE INVENTION

The present invention is an improved trailer hitch receiver tube which is uniquely structured to accept bottom wall corner stress without utilization of prior art receiver tube end portion reinforcement.

In a first preferred aspect, the present invention is an offset receptacle mouth trailer hitch receiver tube, characterized by the receiver tube receptacle walls having an offset disposed at an end portion thereof such that the offset provides an increased receptacle mouth opening size beginning at a predetermined offset inception location, which is spaced from the receiver tube receptacle mouth edge, and extends to the receiver tube receptacle mouth edge. The offset can be any configuration which provides the offsetting of the receiver tube receptacle mouth, as for nonlimiting example an obtusely angled flare, a bellmouth or a stair-step.

In operation with respect to the presence of a drawbar trailer load, the acting receiver tube load is disposed in spaced relation to the receiver tube receptacle mouth edge, interiorly away from the receiver tube receptacle mouth edge and generally at a location of the trailer hitch receiver tube where the tube strength is largely unaffected by the presence of the receiver tube receptacle mouth edge (i.e., disposed deep into the non-offset metal area of the receiver tube). As such, the stress at each of the bottom wall left and bottom wall right corner areas at the receiver tube receptacle mouth edge is lessened by being generally distributed by the receiver tube receptacle walls interiorly spaced from the receiver tube receptacle mouth edge. In addition, the flare or bellmouth of the receiver tube receptacle walls allows for easier alignment and insertion of the drawbar stem into the receiver tube receptacle.

In a second preferred aspect, the present invention is an offset receptacle mouth trailer hitch receiver tube, characterized by the receiver tube receptacle bottom wall having an offset disposed at an end portion thereof such that the offset provides an increased receptacle mouth opening size beginning at a predetermined offset inception location, which is spaced from the receiver tube receptacle mouth edge, and extends to the receiver tube receptacle mouth edge. The offset can be any configuration which provides the offsetting of the receiver tube receptacle mouth at the receiver tube receptacle bottom wall, as for nonlimiting example an obtusely angled flare, a bellmouth or a stair-step.

In operation with respect to the presence of a drawbar trailer load, the acting receiver tube load is disposed in spaced relation to the receiver tube receptacle mouth edge, interiorly away from the receiver tube receptacle mouth edge and generally at a location of the trailer hitch receiver tube where the tube strength is largely unaffected by the presence of the receiver tube receptacle mouth edge (i.e., disposed deep into the non-offset metal area of the receiver tube). As such, the stress at each of the bottom wall left and bottom wall right corner areas at the receiver tube receptacle mouth edge is lessened by being generally distributed by the receiver tube receptacle walls interiorly spaced from the receiver tube receptacle mouth edge.

Accordingly, it is an object of the present invention to provide an offset receptacle mouth trailer hitch receiver tube which accepts bottom wall corner stress without utilization of prior art receiver tube end portion reinforcement.

This and additional objects, features and advantages of the present invention will become clearer from the following specification of a preferred embodiment.

### BRIEF DESCRIPTION OF THE DRAWINGS

FIG. 1 is a perspective view of a prior art trailer hitch, shown connected to the rear of a motor vehicle.

FIG. 2 is a partly sectional schematic side view showing disposition of the acting and reacting receiver loads for a prior art trailer hitch receiver tube in response to a drawbar trailer load applied to the ball of the drawbar.

FIG. 3 is an end view of a prior art receiver tube, showing the lateral distribution of the acting receiver load at the trailer hitch receiver tube receptacle mouth edge thereof.

FIG. 4A is a perspective view of a prior art trailer hitch receiver tube, including receiver tube end portion reinforcement in the form of a welded collar as practiced in the prior art.

FIG. 4B is a perspective view of a prior art receiver tube, including receiver tube end portion reinforcement in the form of a single piece construction as practiced in the prior art.

FIG. 5 is a perspective view of an offset receptacle mouth trailer hitch receiver tube according to a first aspect of the present invention in which all of the receiver tube receptacle walls have an offset, by example in the form of an obtusely angled flare at the receiver tube receptacle mouth.

FIG. 6 is a partly sectional schematic side view showing disposition of the acting and reacting receiver loads for the offset receptacle mouth trailer hitch receiver tube of FIG. 5 in response to a drawbar trailer load acting on the ball of the drawbar.

FIG. 7 is a perspective view of an offset receptacle mouth trailer hitch receiver tube according to a second aspect of the present invention in which the receiver tube receptacle bottom tube wall has an offset, by example in the form of an obtusely angled flare at the receiver tube receptacle mouth.

FIG. 8 is a partly sectional schematic side view showing disposition of the acting and reacting receiver loads for the offset receptacle mouth trailer hitch receiver tube of FIG. 7 in response to a drawbar trailer load acting on the ball of the drawbar.

FIG. 9A is a partly sectional schematic side view of an offset receptacle mouth trailer hitch receiver tube according to the second aspect of the present invention in which the receiver tube receptacle bottom tube wall has an offset by example in the form of an obtusely angled flare which has a curvilinear shape.

FIG. 9B is a partly sectional schematic side view of an offset receptacle mouth trailer hitch receiver tube according to the second aspect of the present invention in which the receiver tube receptacle bottom tube wall has an offset by example in the form of a stair-step.

FIG. 9C is a partly sectional schematic side view of an offset receptacle mouth trailer hitch receiver tube similar to FIG. 9B, wherein now the stair-step is flared.

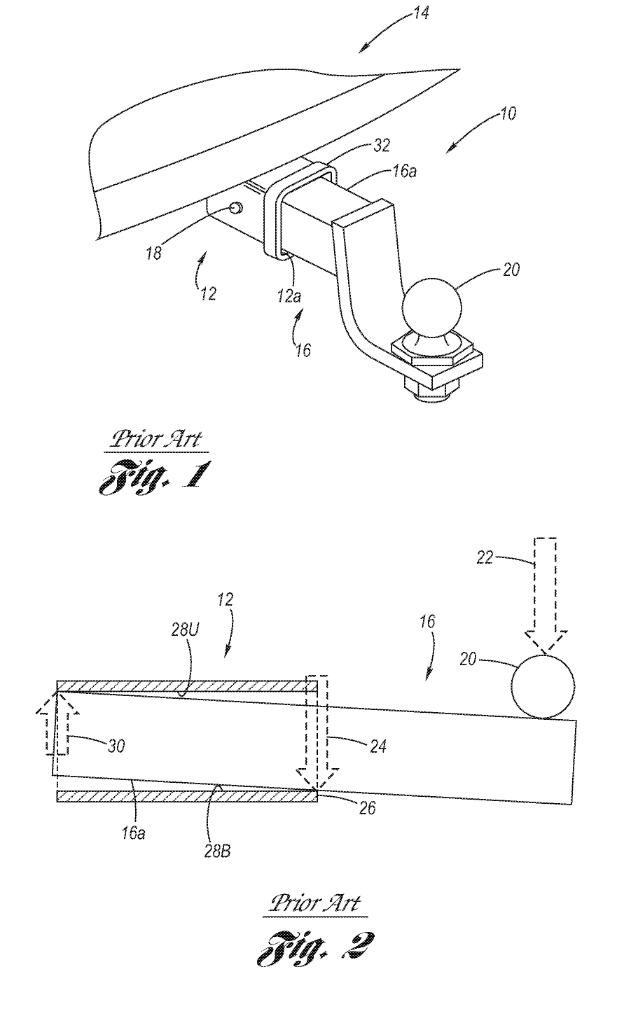

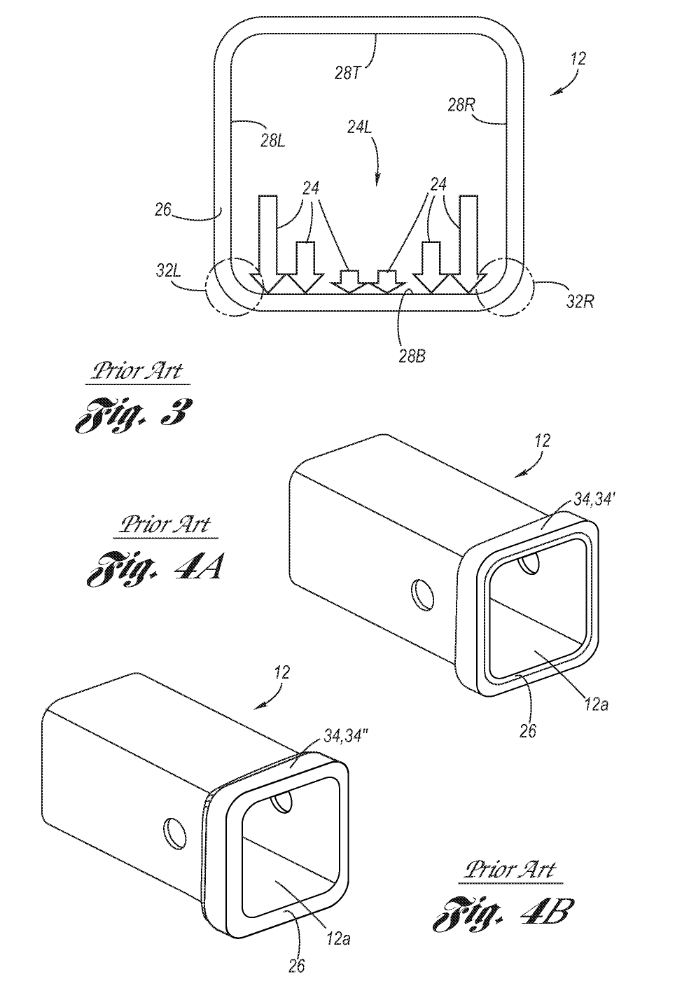

### DESCRIPTION OF THE PREFERRED EMBODIMENT

Referring now to the Drawings, FIGS. 5 through 9C depict examples of an offset receptacle mouth trailer hitch receiver tube 100 according to the present invention, wherein a unique structural characteristic is an offset provided in at least the receiver tube receptacle bottom wall beginning at a predetermined offset inception location, spaced from the receiver tube receptacle mouth edge, and extending to the receiver tube receptacle mouth edge, whereby the offset provides an increased tube receptacle mouth opening size from the flare inception location to the receiver tube receptacle mouth edge.

Turning attention firstly to FIG. 5, a first preferred offset receptacle mouth trailer hitch receiver tube 100, 100′ is characterized by all of its quadrilaterally disposed receiver tube receptacle walls, the receiver tube receptacle top wall 102T, the receiver tube receptacle bottom wall 102B, the receiver tube receptacle left wall 102L and the receiver tube receptacle right wall 102R having an offset O in the form of, by way of example, an obtusely angled flare 104.

The flare 104 commences at an offset inception location 106 which is spaced a distance D away from the receiver tube receptacle mouth edge 108, wherein the obtuse angle A of the flare 104 characterizes the offset O as having an increasing receptacle mouth opening size of the trailer hitch receptacle tube from the offset inception location 106 toward the receiver tube receptacle mouth edge 108.

As depicted schematically at FIG. 6, the drawbar stem 112a of a drawbar 112 is received in the receiver tube receptacle 114 of the offset receiver mouth trailer hitch receiver tube 100′, entering through the receptacle mouth 114a. A drawbar trailer load 116 bears down upon the ball 118 of the drawbar 112, wherein the drawbar trailer load is transferred as an acting receiver tube load 120 disposed upon of the receiver tube receptacle bottom wall 102B at the offset inception location 106, which is located the distance D from the receiver tube receptacle mouth edge 108. The torque moment established between the drawbar trailer load 116 and the acting receiver tube load 120 produces a reacting receiver tube load 122 disposed at the end of the drawbar stem 112a upon the receiver tube receptacle top wall 102T and augments the acting receiver tube load at the offset inception location. Because the acting receiver tube load is disposed at the offset inception location 106 which is spaced the distance D from the receiver tube receptacle mouth edge 108 where the trailer hitch receiver tube strength is largely unaffected by the presence of the receiver tube receptacle mouth edge (i.e., disposed deep into the non-offset metal area of the receiver tube), the stresses at the bottom wall left corner area and bottom wall right corner area are distributed by the non-offset metal and thereby lessened at the receiver tube receptacle mouth edge. For example, in a simulation analysis of a prior art trailer hitch receiver tube and an offset receptacle mouth trailer hitch receiver tube of the present invention, the stress at each of the bottom wall left corner area and bottom wall right corner area at the receiver tube receptacle mouth edge may be 293 MPa for the prior art trailer hitch receiver tube and 135 MPa for the offset receptacle mouth trailer hitch receptacle tube of the present invention.

By way merely of example, the obtuse angle A may range from about 100 degrees to about 160 degrees, and the distance D between the offset inception location 106 and the receiver tube receptacle mouth edge 108 may range from about one-eighth of an inch to about one inch.

An additional advantage the obtuse flare (or bellmouth) of the receiver tube receptacle walls is the increased ease of alignment and insertion of the drawbar stem into the receiver tube receptacle mouth.

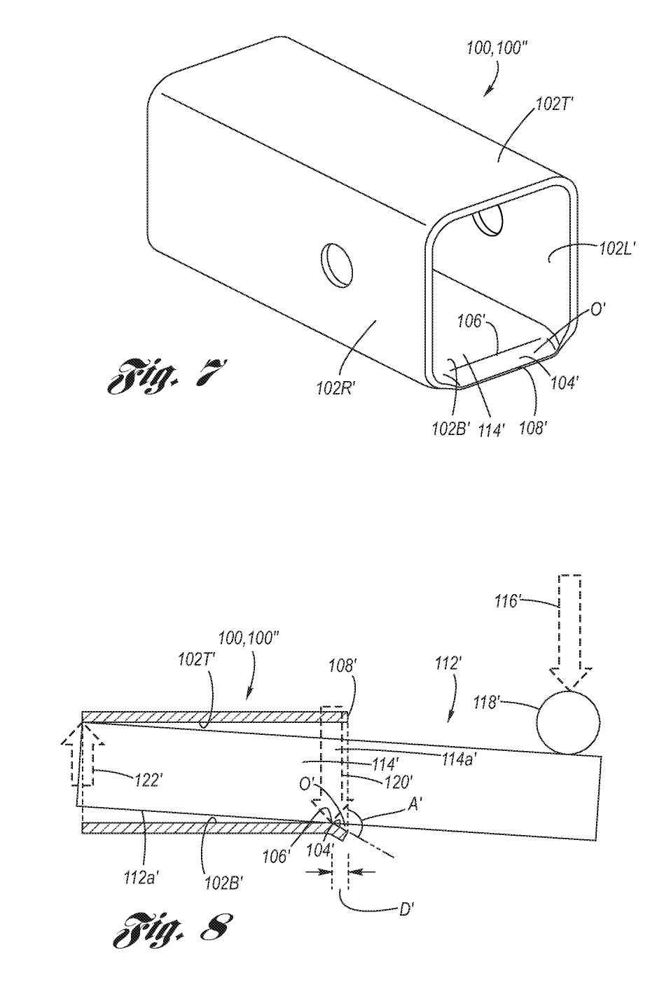

Turning attention now to FIG. 7, the second preferred offset receptacle mouth trailer hitch receiver tube 100, 100″ is characterized by the receiver tube receptacle bottom wall 102B′ having an offset O′ in the form of, for example, an obtusely angled flare 104′. The flare 104′ commences at an offset inception location 106′ which is spaced a distance D′ away from the receiver tube receptacle mouth edge 108′, wherein the obtuse angle A′ of the flare 104′ characterizes the offset O′ as having an increasing receptacle mouth opening size from the offset inception location 106′ toward the receiver tube receptacle mouth edge 108′. By way merely of example, the obtuse angle A′ may range from about 100 degrees to about 160 degrees, and the distance D′ between the offset inception location 106′ and the receiver tube receptacle mouth edge 108′ may range from about one-eighth of an inch to about one inch.

As depicted schematically at FIG. 8, the drawbar stem 112a′ of a drawbar 112′ is received in the receiver tube receptacle 114′ of the offset receptacle mouth trailer hitch receiver tube 100″, entering through the receptacle mouth 114a′. A drawbar trailer load 116′ bears down upon the ball 118′ of the drawbar 112′, wherein the drawbar trailer load is transferred as an acting receiver tube load 120′ disposed upon of the receiver tube receptacle bottom wall 102B′ at the offset inception location 106′, which is located the distance D′ from the receiver tube receptacle mouth edge 108′. The torque moment established between the drawbar trailer load 116′ and the acting receiver tube load 120′ produces a reacting receiver tube load 122′ disposed at the end of the drawbar stem 112a′ upon the receiver tube receptacle top wall 102T′ and augments the acting receiver tube load at the offset inception location. Because the acting receiver tube load is disposed at the offset inception location 106′ which is spaced the distance D′ from the receiver tube receptacle mouth edge 108′ where the trailer hitch receiver tube strength is largely unaffected by the presence of the receiver tube receptacle mouth edge (i.e., disposed deep into the non-offset metal area of the receiver tube), the stresses at the bottom wall left corner area and bottom wall right corner area are distributed by the non-offset metal and thereby lessened at the receiver tube receptacle mouth edge.

### Example I

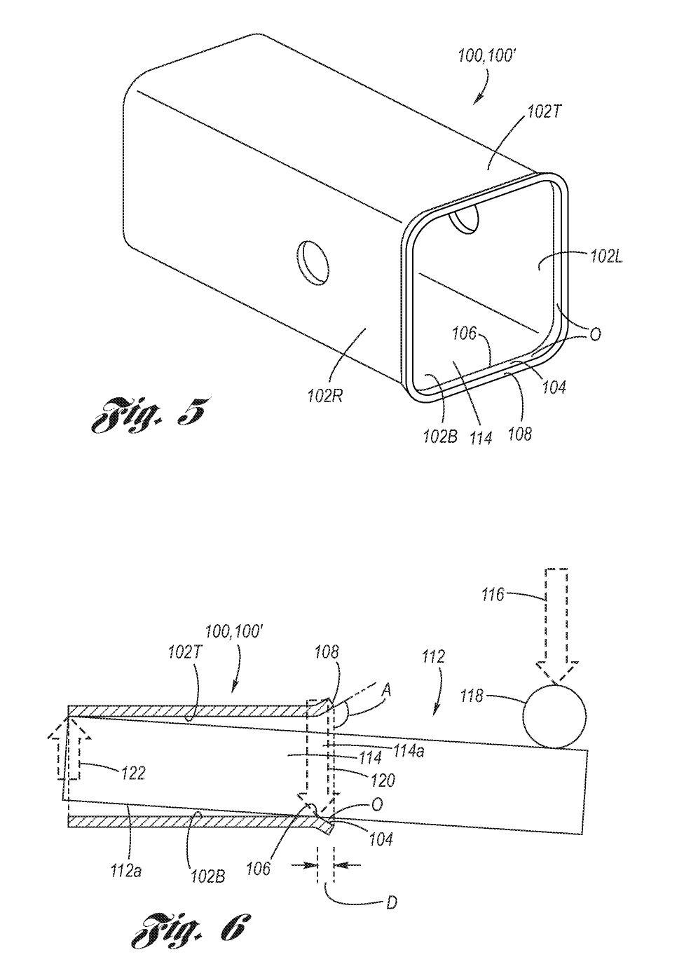

An analytical comparison was conducted, comparing similar sized and composed trailer hitch receiver tubes: a prior art trailer hitch receiver tube (similar to FIG. 2) without a receiver tube end portion reinforcement (“plain tube”), a prior art trailer hitch receiver tube of Colfor Manufacturing (similar to FIG. 4B) of Colfor Manufacturing, Division of American Axle and Manufacturing, Inc., Malvern, Ohio 44644 (“Colfor tube”) wherein the thickness of the receiver tube end portion reinforcement is 12.0 mm, and an offset receptacle mouth trailer hitch receiver tube (similar to FIGS. 7 and 8) according to the present invention (“Flared tube”) wherein the receiver tube bottom receptacle wall has a thickness of 5.0 mm, the offset O′ in the form of a flare 104′ has an obtuse angle A′ of 113 degrees and the offset inception location 106′ is spaced a distance D′ of 10.0 mm from the receiver tube receptacle mouth edge 108′.

The following results were obtained, summarized in Tables I and II.

TABLE I
Membrane Stress and Plastic Strain on Tube Surface

| | 5 kN | 5 kN | 10 kN | 10 KN | 23 KN | 23 KN |
|---|---|---|---|---|---|---|
| | Strain | Stress | Strain | Stress | Strain | Stress |
| Plain tube | .0235 | 443 | 0.51 | 479 | .128 | 549 |
| Colfor tube | .018 | 436 | .0351 | 458 | .078 | 510 |
| Flared tube | .0033 | 419 | .014 | 432 | .0716 | 508 |

TABLE II
Solid Element Stress and Plastic Strain

| | 5 kN | 5 kN | 10 kN | 10 KN | 23 KN | 23 KN |
|---|---|---|---|---|---|---|
| | Strain | Stress | Strain | Stress | Strain | Stress |
| Plain tube | .019 | 371 | .033 | 389 | .12 | 470 |
| Colfor tube | .011 | 361 | .022 | 375 | .078 | 432 |
| Flared tube | .0053 | 354 | .018 | 371 | .10 | 493 |

It will be seen from the foregoing that while the “Colfor tube” performs better than the “Plain tube”, the “Flared tube” according to the present invention performs comparably to the “Colfor tube”, yet is absent the detrimental weight and manufacturing cost of the receiver tube end portion reinforcement shown at FIG. 4B.

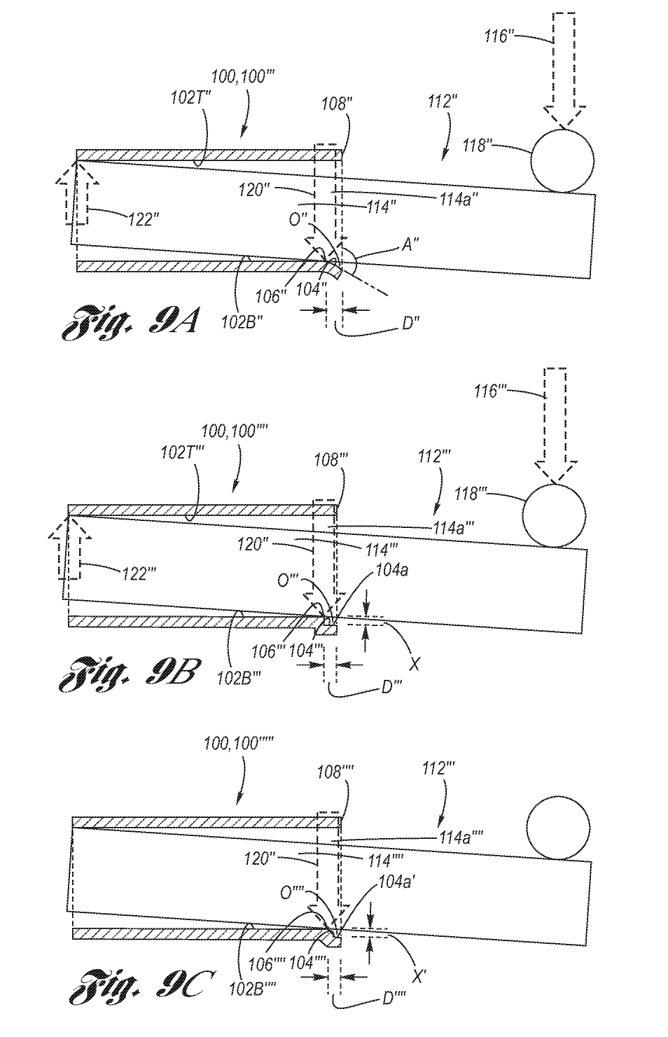

Turning attention now to FIGS. 9A and 9C, alternative forms of the offset will be described as further nonlimiting examples thereof.

Turning attention firstly to FIG. 9A, the second preferred offset receptacle mouth trailer hitch receiver tube 100, 100′″ is characterized by the receiver tube receptacle bottom wall 102B″ having an offset O″ in the form of an obtusely angled flare 104″ having a curvilinear shape (this offset may also apply to the first preferred trailer hitch receptacle tube). The flare 104″ commences at an offset inception location 106″ which is spaced a distance D″ away from the receiver tube receptacle mouth edge 108″, wherein the obtuse angle A″ of the flare 104″ characterizes the offset O″ as having a curvingly increasing receptacle mouth opening size of the trailer hitch receptacle tube from the offset inception location 106″ toward the receiver tube receptacle mouth edge 108″. By way merely of example, the obtuse angle A″ may range from about 100 degrees to about 160 degrees, and the distance D″ between the offset inception location 106″ and the receiver tube receptacle mouth edge 108″ may range from about one-eighth of an inch to about one inch.

As depicted schematically at FIG. 9A, the drawbar stem 112a″ of a drawbar 112″ is received in the receiver tube receptacle 114″ of the offset receptacle mouth trailer hitch receiver tube 100′″, entering through the receptacle mouth 114a″. A drawbar trailer load 116″ bears down upon the ball 118″ of the drawbar 112″, wherein the drawbar trailer load is transferred as an acting receiver tube load 120″ disposed upon of the receiver tube receptacle bottom wall 102B″ at the offset inception location 106″, which is located the distance D″ from the receiver tube receptacle mouth edge 108″. The torque moment established between the drawbar trailer load 116″ and the acting receiver tube load 120″ produces a reacting receiver tube load 122″ disposed at the end of the drawbar stem 112a″ upon the receiver tube receptacle top wall 102T″ and augments the acting receiver tube load at the offset inception location. Because the acting receiver tube load is disposed at the offset inception location 106″ which is spaced the distance D″ from the receiver tube receptacle mouth edge 108″ where the trailer hitch receiver tube strength is largely unaffected by the presence of the receiver tube receptacle mouth edge (i.e., disposed deep into the non-offset metal area of the receiver tube), the stresses at the bottom wall left corner area and bottom wall right corner area are distributed by the non-offset metal and thereby lessened at the receiver tube receptacle mouth edge.

Turning attention next to FIG. 9B, the second preferred offset receptacle mouth trailer hitch receiver tube 100, 100″″ is characterized by the receiver tube receptacle bottom wall 102B″ having an offset O′″ in the form of a stair-step 104′″ (this offset may also apply to the first preferred trailer hitch receptacle tube). The stair-step 104′″ commences at an offset inception location 106′″ which is spaced a distance D′″ away from the receiver tube receptacle mouth edge 108′″, wherein the offset step 104a characterizes the offset O′″, providing an increased receptacle mouth opening size from the offset inception location 106′″ to the receiver tube receptacle mouth edge 108′″. By way merely of example, the stair-step 104′″ may be provided by a pressed expansion of the receiver tube mouth at the receiver tube receptacle bottom wall 102B″, extending the distance D′″ between the receiver tube receptacle mouth edge 108′″ and the offset inception location 106′″, where, for example, D′″ is equal to 5 mm. In this regard, the distance D′″ between the offset inception location 106′″ and the receiver tube receptacle mouth edge 108′″ may range from about one-eighth of an inch to about one inch. The depth X of the offset O′″ is at least sufficient to ensure the drawbar stem 112a′″ does not touch the trailer hitch receiver tube anywhere between the offset inception location and the receiver tube receptacle mouth edge.

As depicted schematically at FIG. 9B, the drawbar stem 112a′″ of a drawbar 112′″ is received in the receiver tube receptacle 114′″ of the offset receptacle mouth trailer hitch receiver tube 100″″, entering through the receptacle mouth 114a′″. A drawbar trailer load 116′″ bears down upon the ball 118′″ of the drawbar 112′″, wherein the drawbar trailer load is transferred as an acting receiver tube load 120′″ disposed upon of the receiver tube receptacle bottom wall 102B′″ at the offset inception location 106′″, which is located the distance D′″ from the receiver tube receptacle mouth edge 108′″. The torque moment established between the drawbar trailer load 116′″ and the acting receiver tube load 120′″ produces a reacting receiver tube load 122′″ disposed at the end of the drawbar stem 112a′″ upon the receiver tube receptacle top wall 102T′″ and augments the acting receiver tube load at the offset inception location. Because the acting receiver tube load is disposed at the offset inception location 106′″ which is spaced the distance D′″ from the receiver tube receptacle mouth edge 108′″ where the trailer hitch receiver tube strength is largely unaffected by the presence of the receiver tube receptacle mouth edge (i.e., disposed deep into the non-offset metal area of the receiver tube), the stresses at the bottom wall left corner area and bottom wall right corner area are distributed by the non-offset metal and thereby lessened at the receiver tube receptacle mouth edge.

Turning attention now to FIG. 9C, the second preferred offset receptacle mouth trailer hitch receiver tube 100, 100′″″ is characterized by the receiver tube receptacle bottom wall 102B″″ having an offset O′″ in the form of a flared stair-step 104″″ (this offset may also apply to the first preferred trailer hitch receptacle tube). The flared stair-step 104″″ has a flare 104b which commences at an offset inception location 106″″ which is spaced a distance D″″ away from the receiver tube receptacle mouth edge 108″″ and ends at an offset step 104a′, wherein the flare and the offset step collectively characterize the offset O″″, providing an increased receptacle mouth opening size from the offset inception location 106″″ to the receiver tube receptacle mouth edge 108″″. By way merely of example, the stair-step 104″″ may be provided by a pressed expansion of the receiver tube mouth at the receiver tube receptacle bottom wall 102B″″, extending the distance D″″ between the receiver tube receptacle mouth edge 108″″ and the offset inception location 106″″, wherein the distance D″″ between the offset inception location 106″″ and the receiver tube receptacle mouth edge 108″″ may range from about one-eighth of an inch to about one inch. The depth X′ of the offset O″″ is at least sufficient to ensure the drawbar stem 112a′″ does not touch the trailer hitch receiver tube anywhere between the offset inception location and the receiver tube receptacle mouth edge.

As depicted schematically at FIG. 9C, the drawbar stem 112a′″ of a drawbar 112′″ is received in the receiver tube receptacle 114″″ of the offset receptacle mouth trailer hitch receiver tube 100′″″, entering through the receptacle mouth 114a″″. The drawbar trailer load is transferred as an acting receiver tube load 120″″ disposed upon of the receiver tube receptacle bottom wall 102B″″ at the offset inception location 106″″, which is located the distance D′″ from the receiver tube receptacle mouth edge 108″″ in the manner generally described hereinabove with respect to FIG. 9B.

While the term “offset” is used herein, it is to be understood that this term refers to any structural configuration which provides an increased receptacle mouth opening size between the offset inception location and the receiver tube receptacle mouth edge, and nonexclusively includes such shapes as flares and stair-steps, wherein the term “flare” includes such shapes as “bellmouths”, “bevels”, “tapers”, etc.

From the foregoing description, it is seen that the offset receptacle mouth trailer hitch receiver tube according to the present invention (absent a receiver tube end portion reinforcement) has a robustness and durability comparable to that of a prior art trailer hitch receiver tube having a receiver tube end portion reinforcement.

To those skilled in the art to which this invention appertains, the above described preferred embodiment may be subject to change or modification. Such change or modification can be carried out without departing from the scope of the invention, which is intended to be limited only by the scope of the appended claims.

1. A trailer hitch receiver tube having an offset receptacle mouth, comprising:
a receiver tube forming a receiver tube receptacle having a receiver tube receptacle mouth edge, said receiver tube comprising a receiver tube receptacle bottom wall;
wherein said receiver tube receptacle bottom wall has an offset beginning at an offset inception location spaced from said receiver tube receptacle mouth edge and extending to said receiver tube receptacle mouth edge.

2. The trailer hitch receiver tube having an offset receptacle mouth of claim 1, wherein said offset comprises an obtusely angled flare beginning at said offset inception location and extending toward said receiver tube receptacle mouth edge.

3. The trailer hitch receiver tube having an offset receptacle mouth of claim 1, wherein said offset comprises a stair-step beginning at said offset inception location and having a step extending to said receiver tube receptacle mouth edge.

4. The trailer hitch receiver tube having an offset receptacle mouth of claim 1, wherein said receiver tube further comprises:
a receiver tube receptacle upper wall;
a receiver tube receptacle left wall; and
a receiver tube receptacle right wall;
wherein said receiver tube receptacle upper wall, said receiver tube receptacle left wall, and said receiver tube receptacle right wall each have a respective offset beginning at a respective offset inception location spaced from said receiver tube receptacle mouth edge and extending to said receiver tube receptacle mouth edge.

5. The trailer hitch receiver tube having an offset receptacle mouth of claim 4, wherein each said offset comprises an obtusely angled flare beginning at its respective offset inception location and extending toward said receiver tube receptacle mouth edge.

6. The trailer hitch receiver tube having an offset receptacle mouth of claim 4, wherein each said offset comprises a stair-step beginning at its respective offset inception location and having a step extending to said receiver tube receptacle mouth edge.

7. A trailer hitch receiver tube having an offset receptacle mouth and drawbar combination, comprising:
a drawbar having a drawbar stem; and
a receiver tube forming a receiver tube receptacle having a receiver tube receptacle mouth edge, said receiver tube comprising a receiver tube receptacle bottom wall;
wherein said receiver tube receptacle bottom wall has an offset beginning at an offset inception location spaced from said receiver tube receptacle mouth edge and extending to said receiver tube receptacle mouth edge; and
wherein when said drawbar stem is received in said receiver tube receptacle and a drawbar trailer load is applied to said drawbar, a resulting active receiver tube load acts on said receiver tube receptacle bottom wall at said offset inception location in spaced relation with respect to said receiver tube receptacle mouth edge.

8. The trailer hitch receiver tube having an offset receptacle mouth and drawbar combination of claim 7, wherein said offset comprises an obtusely angled flare beginning at said offset inception location and extending toward said receiver tube receptacle mouth edge.

9. The trailer hitch receiver tube having an offset receptacle mouth and drawbar combination of claim 7, wherein said offset comprises a stair-step beginning at said offset inception location and having a step extending to said receiver tube receptacle mouth edge.

10. The trailer hitch receiver tube having an offset receptacle mouth and drawbar combination of claim 7, wherein said receiver tube further comprises:
a receiver tube receptacle upper wall;
a receiver tube receptacle left wall; and
a receiver tube receptacle right wall;
wherein said receiver tube receptacle upper wall, said receiver tube receptacle left wall, and said receiver tube receptacle right wall each have a respective offset beginning at a respective offset inception location spaced from said receiver tube receptacle mouth edge and extending to said receiver tube receptacle mouth edge.

11. The trailer hitch receiver tube having an offset receptacle mouth and drawbar combination of claim 10, wherein each said offset comprises an obtusely angled flare beginning at its respective offset inception location and extending toward said receiver tube receptacle mouth edge.

12. The trailer hitch receiver tube having an offset receptacle mouth and drawbar combination of claim 10, wherein each said offset comprises a stair-step beginning at its respective offset inception location and having a step extending to said receiver tube receptacle mouth edge.
